(19) United States
(12) Patent Application Publication
(10) Pub. No.: US 2022/0200014 A1
(43) Pub. Date: Jun. 23, 2022

(54) METHOD OF PRODUCING GAS DIFFUSION LAYER

(71) Applicant: TOYOTA JIDOSHA KABUSHIKI KAISHA, Aichi-ken (JP)

(72) Inventors: Toyohiro SONE, Toyota-shi (JP); Ryosuke MAEKAWA, Tahara-shi (JP)

(21) Appl. No.: 17/525,970

(22) Filed: Nov. 15, 2021

(30) Foreign Application Priority Data
Dec. 22, 2020 (JP) 2020-212633

(51) Int. Cl. H01M 4/88; H01M 8/1081

(52) U.S. Cl. CPC H01M 4/8885; H01M 4/8892; H01M 8/1081; H01M 4/8807

(57) ABSTRACT

One aspect of the present disclosure relates to a method of producing a gas diffusion layer including a water repellent material dispersion preparation process in which a water repellent material, a viscosity adjusting agent and a solvent are mixed to obtain a water repellent material dispersion; an impregnation process in which a substrate is impregnated with the water repellent material dispersion; and a firing process in which the substrate impregnated with the water repellent material dispersion is fired, wherein the viscosity of the water repellent material dispersion in the water repellent material dispersion preparation process is 0.04 Pa·s@100 s⁻¹ or more.

### CROSS-REFERENCE TO RELATED APPLICATION

This application claims priority to Japanese Patent Application No. 2020-212633 filed on Dec. 22, 2020, incorporated herein by reference in its entirety.

### BACKGROUND

### 1. Technical Field

The present disclosure relates to a method of producing a gas diffusion layer used in a fuel cell.

### 2. Description of Related Art

In a fuel cell, an electromotive force is obtained by electrochemically reacting hydrogen with oxygen. A product generated according to power generation of a fuel cell is, in principle, only water. Therefore, the fuel cell has been focused upon as a clean power generation system with little burden on the global environment.

A fuel cell is composed of a membrane electrode assembly (hereinafter referred to as “MEA”) in which an electrode catalyst layer is disposed on both surfaces of an electrolyte membrane as a basic unit. When the fuel cell operates, an electromotive force is obtained by supplying a fuel gas containing hydrogen to the electrode catalyst layer on the side of an anode (fuel electrode) and an oxidizing gas containing oxygen to the electrode catalyst layer on the side of a cathode (air electrode). An oxidation reaction proceeds in the anode, a reduction reaction proceeds in the cathode, and an electromotive force is supplied to an external circuit.

In a fuel cell, generally, a gas diffusion layer is disposed outside each electrode catalyst layer of an MEA and a separator is additionally disposed outside the gas diffusion layer to form a fuel cell. Fuel cells are generally used in a combination of a plurality of required fuel cells (hereinafter referred to as a “fuel cell stack”) based on desired power.

The gas diffusion layer generally has a two-layer structure including a water repellent layer and a porous substrate (for example, carbon paper). The water repellent layer is generally formed by applying a paste obtained by mixing a water repellent compound (for example, polytetrafluoroethylene (hereinafter referred to as “PTFE”)), carbon and a surfactant with water to the surface of the porous substrate.

For example, Japanese Unexamined Patent Application Publication No. 10-32009 (JP 10-32009 A) describes that a dispersion in which PTFE and a surfactant are dispersed in water is sprayed or applied to a porous carbon substrate to perform a water repellent treatment.

Japanese Unexamined Patent Application Publication No. 2020-145075 (JP 2020-145075 A) describes a method of producing a microporous layer paste including a first process in which conductive particles, water-repellent particles, a dispersant, and water are mixed and dispersed in a predetermined ratio, and a second process in which a hydrophobic organic solvent as a thickener is added to and mixed with the dispersion obtained in the first process.

### SUMMARY

As described above, in the production of a known gas diffusion layer, a paste in which a water repellent compound such as PTFE is dispersed in water together with a surfactant is applied to the surface of the substrate to form a water repellent layer. However, in the case of the gas diffusion layer produced by such a method, the paste forming the water repellent layer could penetrate the substrate, and as a result, there was a risk of gas diffusivity being hindered. The causes of paste penetration include, for example, low surface tension of the paste and high wettability of the substrate. The low surface tension of the paste is caused by the surfactant used for dispersing the water repellent compound.

The inventors have found that, by obtaining PTFE derivatives having a hydrophilic group by plasma emission, a paste of the PTFE derivatives having a hydrophilic group can be prepared without using a surfactant, and developed a method of producing a gas diffusion layer using the paste (Japanese Patent Application No. 2020-046655 (JP 2020-046655 A). In the method, a surfactant that lowers the surface tension is not used. Therefore, according to the method, a gas diffusion layer of the fuel cell can be produced without lowering the surface tension of the paste. However, in the case of this method, there is a problem of high cost.

Therefore, the present disclosure provides a method of producing a gas diffusion layer of a fuel cell having a low wettability substrate at low cost.

The inventors have studied various methods for solving the above problems. The inventors have found that, when a water repellent treatment is performed on a substrate using a water repellent material dispersion having a viscosity adjusted to a predetermined range, a gas diffusion layer having a low wettability substrate can be produced without performing a high-cost treatment. The inventors completed the present disclosure based on the above findings.

That is, the present disclosure includes the following aspects and embodiments.

(1) A method of producing a gas diffusion layer, including:

a water repellent material dispersion preparation process in which a water repellent material, a viscosity adjusting agent and a solvent are mixed to obtain a water repellent material dispersion;

an impregnation process in which a substrate is impregnated with the water repellent material dispersion; and

a firing process in which the substrate impregnated with the water repellent material dispersion is fired,
wherein the viscosity of the water repellent material dispersion in the water repellent material dispersion preparation process is 0.04 Pa·s@100 s⁻¹ or more.
   (2) The method according to the embodiment (1), wherein the viscosity adjusting agent is one or more compounds selected from the group consisting of polyethylene oxide, hydroxyethyl cellulose and carboxymethyl cellulose.
   (3) The method according to the embodiment (1) or (2), wherein the water repellent material dispersion contains 0.5 mass % or more of the viscosity adjusting agent with respect to a total mass.
   (4) The method according to any one of the embodiments (1) to (3), wherein the water repellent material is a fluororesin.

According to the present disclosure, it is possible to provide a method of producing a gas diffusion layer of a fuel cell having a low wettability substrate at low cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relationship between a viscosity adjusting agent concentration and a viscosity of a water repellent material dispersion in Experiment I-1;

FIG. 2 is a graph showing the relationship between a viscosity of a water repellent material dispersion used for a surface treatment of carbon paper and a contact angle of an evaluation paste on the surface of the carbon paper in Experiment I-2;

FIG. 3A shows an image of the surface of the carbon paper in contact angle measurement in Experiment I-2, and FIG. 3A is an image of carbon paper impregnated with a water repellent material dispersion containing no PEO;

FIG. 3B shows an image of the surface of the carbon paper in contact angle measurement in Experiment I-2, and FIG. 3B is an image of carbon paper impregnated with a water repellent material dispersion containing 0.1 mass % of PEO;

FIG. 3C shows an image of the surface of the carbon paper in contact angle measurement in Experiment I-2, and FIG. 3C is an image of carbon paper impregnated with a water repellent material dispersion containing 0.5 mass % of PEO; and

FIG. 3D shows an image of the surface of the carbon paper in contact angle measurement in Experiment I-2, and FIG. 3D is an image of carbon paper impregnated with a water repellent material dispersion containing 1 mass % of PEO.

### DETAILED DESCRIPTION OF EMBODIMENTS

Hereinafter, preferable embodiments of the present disclosure will be described in detail.

### <1. Method of Producing Gas Diffusion Layer>

In the case of a gas diffusion layer of a fuel cell produced by a method in the related art, a paste forming a water repellent layer could penetrate a substrate, and as a result, there was a risk of gas diffusivity being hindered. The causes of paste penetration include, for example, low surface tension of the paste and high wettability of the substrate. The low surface tension of the paste is caused by the surfactant used for dispersing the water repellent compound.

In the method of producing a gas diffusion layer developed by the inventors, when PTFE derivatives having a hydrophilic group are obtained by plasma emission, a paste of PTFE derivatives having a hydrophilic group can be prepared without using a surfactant (JP 2020-046655 A). In the method, a surfactant that lowers the surface tension is not used. Therefore, according to the method, a gas diffusion layer of the fuel cell can be produced without lowering the surface tension of the paste. However, in the case of this method, there is a problem that cost for the plasma treatment is high. The reason for high cost is that, for example, since it is necessary to add a process of obtaining PTFE derivative powder by plasma emission, and a product according to the plasma treatment has a powder form, it is difficult to collect substantially all products.

One aspect of the present disclosure relates to a method of producing a gas diffusion layer. The production method of this aspect includes a water repellent material dispersion preparation process, an impregnation process and a firing process. According to the method of this aspect, it is possible to produce a gas diffusion layer of a fuel cell having a low wettability substrate at low cost. Therefore, it is possible to produce a gas diffusion layer having high gas diffusivity.

### [1-1. Water Repellent Material Dispersion Preparation Process]

This process includes mixing a water repellent material, a viscosity adjusting agent and a solvent to obtain a water repellent material dispersion.

The water repellent material used in this process is preferably a fluororesin and more preferably polytetrafluoroethylene (PTFE). The water repellent material exemplified above can be used without particular limitation as long as it has a purity generally used in the art. In addition, the form of the water repellent material is generally powder. For the water repellent material, any of the compounds exemplified above may be used alone or one or more compounds may be used in combination. The water repellent material may be prepared by purchasing a product having the characteristics described above, or may be prepared by self purification or production.

The viscosity adjusting agent used in this process is preferably one or more compounds selected from the group consisting of polyethylene oxide (PEO), hydroxyethyl cellulose (HEC) and carboxymethyl cellulose (CMC), and more preferably PEO. The viscosity adjusting agents exemplified above can be used without particular limitation as long as they have a purity generally used in the art. In addition, the form of the viscosity adjusting agent is generally a liquid or a solid. The molecular weight of the viscosity adjusting agent is preferably in a range of 2,000,000 to 5,000,000. For the viscosity adjusting agent, any of the compounds exemplified above may be used alone or one or more compounds may be used in combination. The viscosity adjusting agent may be prepared by purchasing a product having the characteristics described above, or may be prepared by self purification or production.

The solvent used in this process is preferably one or more compounds selected from the group consisting of water and lower alcohols (for example, ethanol), and more preferably water. For the solvent, any of the compounds exemplified above may be used alone or one or more compounds may be used in combination. The solvent may be prepared by purchasing a product having the characteristics described above, or may be prepared by self purification or production.

In this process, the water repellent material, viscosity adjusting agent and solvent exemplified above are mixed to obtain a water repellent material dispersion. Here, it is found that, when a water repellent treatment is performed on a substrate using a water repellent material dispersion having a viscosity adjusted to a predetermined range, a gas diffusion layer having a low wettability substrate can be produced without performing a high-cost treatment. The viscosity of the water repellent material dispersion is 0.04 Pa·s@100 s⁻¹ or more and is preferably in a range of 0.04 to 1 Pa·s@100 s⁻¹. When the viscosity of the water repellent material dispersion is less than the lower limit value, the contact angle of the resulting gas diffusion layer on the surface of the substrate may be low and the wettability may be high. In addition, when the viscosity of the water repellent material dispersion exceeds the upper limit value, the coatability in the impregnation process described below may be lowered. Therefore, when the viscosity of the water repellent material dispersion is within the above range, a gas diffusion layer of a fuel cell having a low wettability substrate can be produced at low cost.

In each aspect of the present disclosure, the viscosity of the water repellent material dispersion can be measured using, for example, a rheometer.

In the water repellent material dispersion, the content of the viscosity adjusting agent with respect to a total mass is preferably 0.5 mass % or more and more preferably in a range of 0.5 mass % to 1.2 mass %. When the content of the viscosity adjusting agent is less than the lower limit value, the viscosity of the water repellent material dispersion may be less than the lower limit value described above. In addition, when the content of the viscosity adjusting agent exceeds the upper limit value, the dispersibility of the water repellent material in the water repellent material dispersion may decrease. Therefore, when the content of the viscosity adjusting agent in the water repellent material dispersion is within the range, a gas diffusion layer of a fuel cell having a low wettability substrate can be produced at low cost.

### [1-2. Impregnation Process]

This process includes impregnating a substrate with the water repellent material dispersion obtained in the water repellent material dispersion preparation process.

The substrate used in this process may be various porous substrates generally used in the art such as carbon fibers (for example, carbon paper, carbon felt, carbon cloth, carbon fiber fabric, carbon fiber paper body or carbon fiber non-woven fabric) and foam sintered metals.

In this process, a method of impregnating a substrate with a water repellent material dispersion is not particularly limited. For example, the method can be performed by immersing a substrate in a water repellent material dispersion or applying a water repellent material dispersion to a substrate. When this process is performed by this method, the water repellent material dispersion can be distributed over the entire substrate.

### [1-3. Firing Process]

This process includes firing the substrate impregnated with the water repellent material dispersion obtained in the impregnation process.

In this process, the method of firing a substrate is not particularly limited. Firing can be performed by a device such as an electric furnace generally used in the art. The firing temperature is preferably in a range of 300° C. to 400° C. When the temperature is less than the lower limit value, solvent and/or viscosity adjusting agent may remain. In addition, when the temperature exceeds the upper limit value, the water repellent material may be thermally decomposed. When this process is performed with the above device and conditions, a low wettability substrate can be obtained.

In each aspect of the present disclosure, the wettability of the substrate can be evaluated, for example, by measuring the contact angle of the substrate using a contact angle meter.

The reason why the above operations and effects are exhibited in each aspect of the present disclosure can be explained as follows. Here, each aspect of the present disclosure is not limited to the following operations and principles. When the impregnation process is performed, the water repellent material dispersion is substantially uniformly distributed over the entire substrate, and particularly, the entire surface of fibers inside the substrate. Next, in the firing process, the substrate impregnated with the water repellent material dispersion obtained in the impregnation process is fired, and thus the solvent and/or the viscosity adjusting agent contained in the water repellent material dispersion is volatilized, and the dried water repellent material remains on the surface of the fibers inside the substrate. Here, when the viscosity of the water repellent material dispersion is less than the lower limit value, since the water repellent material dispersion aggregates between the fibers of the substrate and is dried while forming a liquid film, it may be unlikely to uniformly remain on the surface of the fibers in the substrate. On the other hand, when the viscosity of the water repellent material dispersion is within the above range, the viscosity of the water repellent material dispersion can act as a drag force for aggregation between the fibers in the substrate. As a result, the dried water repellent material can be substantially uniformly disposed over the entire surface of fibers inside the substrate. Therefore, when the method of this aspect is performed, a gas diffusion layer of a fuel cell having a low wettability substrate can be produced at low cost.

### [1-4. Paste Preparation Process]

The method of this aspect includes a paste preparation process, if desired. This process includes mixing carbon, a water repellent material and a viscosity adjusting agent with a solvent to obtain a paste.

The carbon used in this process may be various carbon materials generally used in the art such as carbon black, carbon nanotubes, carbon nanofibers, carbon fibers, graphene or graphite.

This process can be performed by uniformly dispersing components by a device generally used in the art such as a stirrer or an ultrasonic homogenizer.

### [1-5. Application Process]

The method of this aspect includes an application process, if desired. This process includes applying the paste obtained in the paste preparation process to the surface of the substrate obtained in the firing process to obtain a gas diffusion layer.

This process can be performed by a method generally used in the art such as a spray application method, a screen printing method, a blade application method or a coater application method.

As described above, the substrate obtained in the firing process has low wettability. Therefore, when the paste is applied to the surface of the substrate, it is possible to substantially minimize penetration of the paste into the substrate and it is possible to form a water repellent layer on the surface of the substrate. Therefore, according to this process, a gas diffusion layer having high gas diffusivity can be obtained.

### <2. Substrate for Gas Diffusion Layer and Gas Diffusion Layer>

As described above, according to the production method of one aspect of the present disclosure, a low wettability substrate and a gas diffusion layer using the same can be obtained. Therefore, another aspect of the present disclosure relates to a substrate for a gas diffusion layer and a gas diffusion layer.

The substrate of one aspect of the present disclosure can be used to form a gas diffusion layer of a fuel cell.

The substrate of this aspect has a water repellent material that is substantially uniformly disposed over the entire substrate, and particularly, the entire surface of fibers inside the substrate. The substrate and the water repellent material preferably have the characteristics described above.

The substrate of this aspect has low wettability. The substrate of this aspect having such characteristics can substantially minimize penetration of the paste for forming a water repellent layer into the substrate. Therefore, when the substrate of this aspect is used, a gas diffusion layer having high gas diffusivity can be obtained.

The gas diffusion layer of another aspect of the present disclosure has a substrate having the characteristics described above and a water repellent layer disposed on the surface of the substrate. The water repellent layer is substantially not disposed inside the substrate. The water repellent layer is formed of a paste having the characteristics described above.

As described above in detail, according to the production method of one aspect of the present disclosure, a gas diffusion layer of a fuel cell having a low wettability substrate can be produced at low cost. Thereby, a gas diffusion layer having high gas diffusivity can be obtained.

The present disclosure will be described below in more detail with reference to examples. However, the technical scope of the present disclosure is not limited to these examples.

### <I: Production of Gas Diffusion Layer>

### [I-1: Preparation of Water Repellent Material Dispersion]

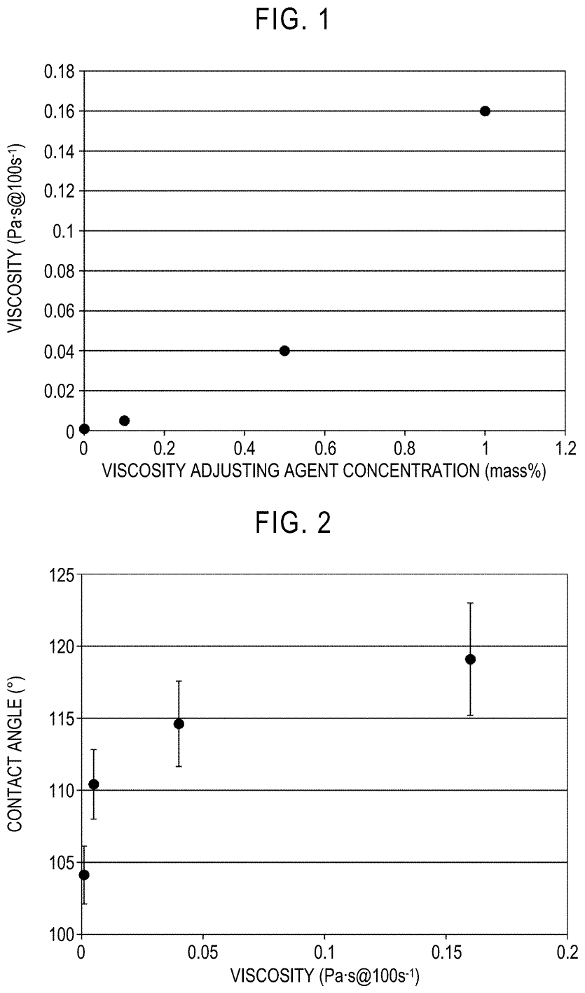

PTFE was used as a water repellent material and PEO was used as a viscosity adjusting agent. A 60 mass % PTFE dispersion was diluted with deionized water. PEO was added to the PTFE dispersion so that a predetermined PEO concentration (0 mass %, 0.1 mass %, 0.5 mass % or 1 mass %) was obtained, and thereby a water repellent material dispersion was obtained. The viscosity of the obtained water repellent material dispersion was evaluated using a rheometer (DISCOVERYHR-2 commercially available from TA Instruments). FIG. 1 shows the relationship between the viscosity adjusting agent concentration and the viscosity of the water repellent material dispersion.

As shown in FIG. 1, the viscosity of the prepared water repellent material dispersion was in a range of 0.001 to 0.16 Pa·s@100 s⁻¹.

### [I-2: Impregnation of Water Repellent Material Dispersion]

Carbon paper was used as a substrate. Carbon paper was impregnated with four types of water repellent material dispersions prepared in Experiment I-1 at room temperature for 10 seconds. Thereby, the water repellent material dispersion was distributed over all the fibers inside the carbon paper.

### [I-3: Firing of Substrate]

The four types of carbon paper prepared in Experiment I-2 were put into a furnace at 400° C. and fired for 10 minutes. Thereby, four types of carbon paper with the surface treated with the water repellent material were obtained.

### <II: Evaluation of Performance of Gas Diffusion Layer>

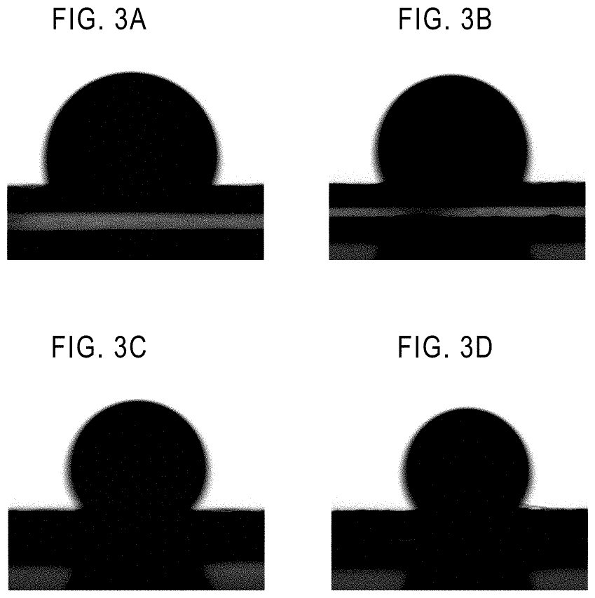

A contact angle between four types of carbon paper with the surface treated with the water repellent material obtained in Experiment I and an evaluation paste was measured. The evaluation paste was prepared by dispersing carbon, a water repellent material and a viscosity adjusting agent in water. For the water repellent material and the viscosity adjusting agent, the same compounds as in Experiment I were used. The contact angle was measured using a contact angle meter (DropMaster500 commercially available from Kyowa Interface Science, Inc). The contact angle was measured 10 times for each carbon paper and the average value and the standard deviation of the contact angles were calculated. FIG. 2 shows the relationship between the viscosity of the water repellent material dispersion used in the carbon paper surface treatment and the contact angle of the evaluation paste on the surface of the carbon paper. In addition, FIG. 3A to FIG. 3D show images of the surface of each carbon paper in contact angle measurement. FIG. 3A is an image of carbon paper impregnated with a water repellent material dispersion containing no PEO, FIG. 3B is an image of carbon paper impregnated with a water repellent material dispersion containing 0.1 mass % of PEO, FIG. 3C is an image of carbon paper impregnated with a water repellent material dispersion containing 0.5 mass % of PEO, and FIG. 3D is an image of carbon paper impregnated with a water repellent material dispersion containing 1 mass % of PEO.

As shown in FIG. 2 and FIG. 3A to FIG. 3D, in carbon paper impregnated with a water repellent material dispersion having a viscosity of 0.04 Pa·s@100 s⁻¹ or more, a contact angle of about 115° or more is shown (FIGS. 3C and 3D). The contact angle was approximately the same as the contact angle of the gas diffusion layer produced by the method including a plasma emission process disclosed in JP 2020-046655 A. The water repellent material dispersion having a viscosity of 0.04 Pa·s@100 s⁻¹ or more corresponded to the water repellent material dispersion containing 0.5 mass % or more of PEO as the viscosity adjusting agent. Therefore, when the surface of the substrate was treated with a water repellent material dispersion containing 0.5 mass % or more of a viscosity adjusting agent, it was possible to increase the contact angle on the surface of the resulting gas diffusion layer and lower the wettability.

Here, the present disclosure is not limited to the above examples, and includes various modifications. For example, the above examples have been described in detail in order to explain the present disclosure in an easy to understand manner, and the present disclosure is not necessarily limited to having all the configurations described. In addition, it is possible to add, delete and/or replace some of the configurations of each example with other configurations.

What is claimed is:

1. A method of producing a gas diffusion layer, comprising:
a water repellent material dispersion preparation process in which a water repellent material, a viscosity adjusting agent and a solvent are mixed to obtain a water repellent material dispersion;
an impregnation process in which a substrate is impregnated with the water repellent material dispersion; and
a firing process in which the substrate impregnated with the water repellent material dispersion is fired,
wherein the viscosity of the water repellent material dispersion in the water repellent material dispersion preparation process is 0.04 Pa·s@100 s⁻¹ or more.

2. The method according to claim 1,
wherein the viscosity adjusting agent is one or more compounds selected from the group consisting of polyethylene oxide, hydroxyethyl cellulose and carboxymethyl cellulose.

3. The method according to claim 1,
wherein the water repellent material dispersion contains 0.5 mass % or more of the viscosity adjusting agent with respect to a total mass.

4. The method according to claim 1,
wherein the water repellent material is a fluororesin.
